(19) United States
(12) Patent Application Publication
(10) Pub. No.: US 2013/0057678 A1
(43) Pub. Date: Mar. 7, 2013

(54) INSPECTION SYSTEM AND METHOD OF DEFECT DETECTION ON SPECULAR SURFACES

(71) Applicants: Miguel Angel Prior Carrillo, Valencia (ES); Jose Simon Plaza, Cullera (ES); Alvaro Herraez Martinez, Paiporta (ES); Jose Manuel Asensio Munoz, Rocafort (ES); Josep Tornero Monserrat, Valencia (ES); Ana Virginia Ruescas Nicolau, Valencia (ES); Leopoldo Armesto Angel, Valencia (ES)

(72) Inventors: Miguel Angel Prior Carrillo, Valencia (ES); Jose Simon Plaza, Cullera (ES); Alvaro Herraez Martinez, Paiporta (ES); Jose Manuel Asensio Munoz, Rocafort (ES); Josep Tornero Monserrat, Valencia (ES); Ana Virginia Ruescas Nicolau, Valencia (ES); Leopoldo Armesto Angel, Valencia (ES)

(73) Assignee: FORD ESPANA S.L., Alcobendas, Madrid (ES)

(21) Appl. No.: 13/697,086

(22) PCT Filed: May 17, 2010
(86) PCT No.: PCT/IB10/52193

§ 371 Date: Nov. 9, 2012

(51) Int. Cl. H04N 7/18

(52) U.S. Cl. 348/125; 348/E05.027

(57) ABSTRACT

An inspection system and a method of detecting defects on specular surfaces. The inspection system may include an illumination subsystem that moves with respect to an article, e.g. a vehicle, to be inspected. A vision subsystem may gather images of light reflected from the article and execute a methodology to detect defects on one or more surfaces of the article.

### BACKGROUND OF THE INVENTION

1. Field of the Invention

The present invention relates to an inspection system and a method of detecting defects on specular surfaces.

### SUMMARY OF THE INVENTION

In at least one embodiment an inspection system for detecting defects on a surface of an article is provided. The inspection system includes a support structure, an illumination subsystem, and a vision subsystem. The illumination subsystem has a plurality of light sources that move linearly with respect to the support structure. The vision subsystem includes stationary first and second cameras. The first and second cameras have overlapping first and second prisms of vision. Movement of the plurality of light sources produces a reflection that sweeps the surface between two opposing walls of the first and second prisms of vision.

In at least one embodiment a method of inspecting an article for surface defects is provided. The method includes acquiring images of a surface of the article with a camera as a light source is moved with respect to the article. Images acquired by the camera are merged. A merged image is blurred to compensate for variations in levels of illumination provided by the light source. Defects are detected based on blurring of the merged image.

In at least one embodiment a method of inspecting an article for surface defects is provided. The method includes positioning the article in a stationary position, actuating an illumination subsystem having a light source such that light reflects off the surface, capturing images of light reflecting off the article with a camera, processing the images to detect the presence of a defect on the surface, and displaying a location of a defect.

### BRIEF DESCRIPTION OF THE DRAWINGS

FIG. 1 is an end view of an exemplary embodiment of an inspection system having a plurality of cameras.

FIG. 2 is a side view of the inspection system of FIG. 1 showing a light subsystem in a first position.

FIG. 3 is a side view of the inspection system showing the light subsystem in a second position.

FIG. 4 is a side view showing positioning of cameras with respect to an article.

FIG. 5 is a top view showing positioning of cameras with respect to the article.

FIGS. 6-10 illustrate cones of vision of cameras associated with the inspection system.

FIG. 11 is a flowchart depicting a method of detecting defects.

FIG. 12 illustrates a sample image acquired by the inspection system.

FIG. 13 is an example of a merged image based on a plurality of images captured by one or more cameras.

FIG. 14 illustrates an example of a blurred image.

FIG. 15 is an example of a threshold values image.

FIG. 16 is an example of a mask image.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

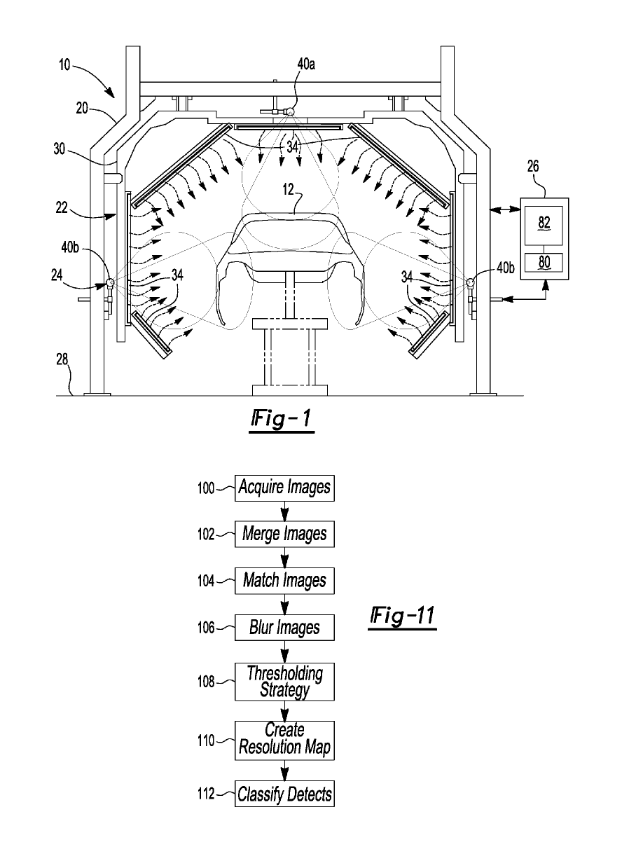

Referring to FIGS. 1-3, an exemplary inspection system 10 is shown. The inspection system 10 may be configured to detect defects on a surface of an article 12, such as coating defects on a coated or painted article or other surface defects. In a vehicular application, the article to be inspected may be a vehicle body component or body structure, such as an automobile body or aircraft or boat hull.

The inspection system 10 may be provided as part of an assembly line. The inspection system 10 may be located at any suitable point on the assembly line where it is desired to detect possible surface defects. For example, the inspection system 10 may be provided following a sheet pressing operation, after a priming phase, or after a painting or lacquering phase.

The inspection system 10 may include a support structure 20, an illumination subsystem 22, a vision subsystem 24, and a control subsystem 26.

The support structure 20 may be configured to support the illumination subsystem 22 and/or the vision subsystem 24. The support structure 20 may be configured as a frame that is disposed on a support surface 28, such as a floor. In at least one embodiment, the support structure 20 may be generally configured as a tunnel through which the article 12 passes.

The illumination subsystem 22 may be configured as a porticoed structure that may include a plurality of illumination arches 30. In the embodiment shown, eleven illumination arches 30 are provided, but a greater or lesser number may be employed depending on the size and configuration of the article 12 being inspected. Each illumination arch 30 may be substantially equally spaced apart from an immediately adjacent arch in one or more embodiments. In addition, the illumination arches 30 may be disposed substantially parallel to each other and may be disposed in a generally vertical orientation. The illumination arches 30 may be mounted on a common support member or rail such that the plurality of illumination arches 30 may move together as a unit along an axis with respect to the article 12 and between first and second opposing ends of the support structure 20.

Each illumination arch 30 may include a frame 32 that supports one or more light sources 34. The light sources 34 may be of any suitable type, such as fluorescent light tubes that may be positioned to illuminate one or more surfaces of the article 12 to be inspected. As such, the shape or configuration of the light sources 34 may have an area of high intensity or be visible in the reflection from the surface. In addition, each illumination arch 30 may at least partially surround the article 12 to provide substantially uniform light sweeping. In the embodiment shown, each illumination arch 30 may include seven light sources 34: a horizontal superior position light source (near the top of the illumination arch 30), left and right oblique superior position light sources (extending at an angle from the ends of superior position light source), left and right vertical position light sources (extending from an end of each oblique superior position light source), and left and right oblique inferior position light sources (extending from an end of each vertical position light source). In addition, a second horizontal light source may be provided that extends at least partially under the article. For instance, the second horizontal light source may extend between the left and right oblique inferior position light sources. As such, the light sources 34 may be arranged in a substantially octagonal configuration.

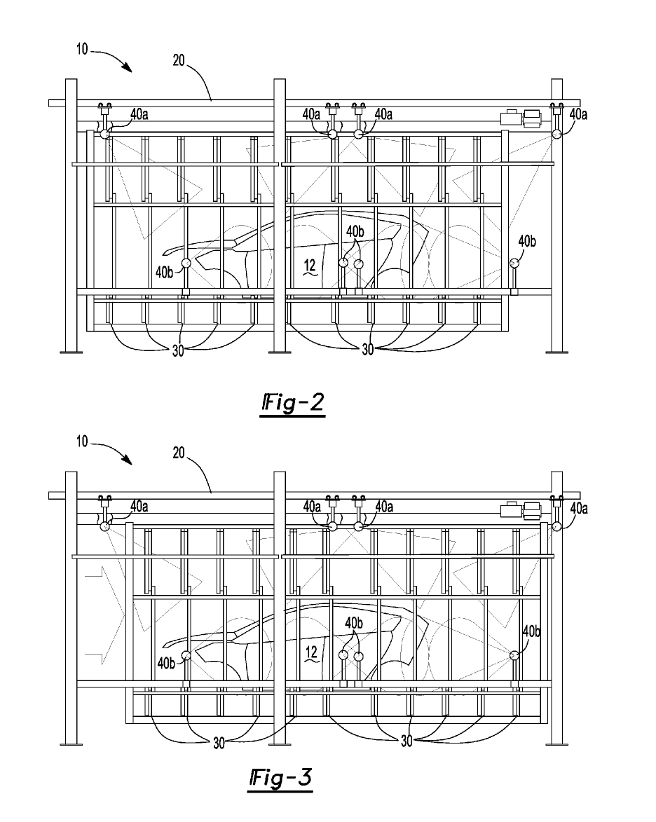

The illumination subsystem 22 may be configured to move with respect to the support structure 20. For instance, the illumination subsystem 22 may be moveably disposed on the support structure 20 in any suitable manner. For instance, the illumination subsystem 22 may be disposed on a plurality of rollers or a guide track. An actuator may be configured to actuate the illumination subsystem 22 between a first position and a second position. In an exemplary first position, such as may be shown in FIG. 2, the illumination subsystem 22 may be disposed near a first end of the support structure 20. In an exemplary second position, such as may be shown in FIG. 3, the illumination subsystem 22 may be disposed near a second end of the support structure 20 disposed opposite the first end. The actuator may be of any suitable type, such as a motor, hydraulic cylinder, or pneumatic cylinder.

The vision subsystem 24 may include a plurality of cameras 40 that are fixedly disposed relative to the article to be inspected. The cameras 40 may be disposed on the support structure 20 and may be in communication with the control subsystem 26. The control subsystem 26 may be configured to process image data provided by each camera 40, control movement of the illumination subsystem 22, and/or display data to an operator.

The cameras 40 may be positioned to detect light from the illumination subsystem 22 that may be reflected by the article 12 to be inspected. Each camera 40 may have a prism of vision or field of view that is graphically represented by lines extending from each camera 40 in FIGS. 1-5. For clarity, the field of view lines may be illustrated as being spaced apart from the article 12, but such spacing is not intended to indicate that a camera 40 does not capture images of or light reflecting from the article 12.

Any suitable number of cameras 40 may be provided. In the embodiment shown in

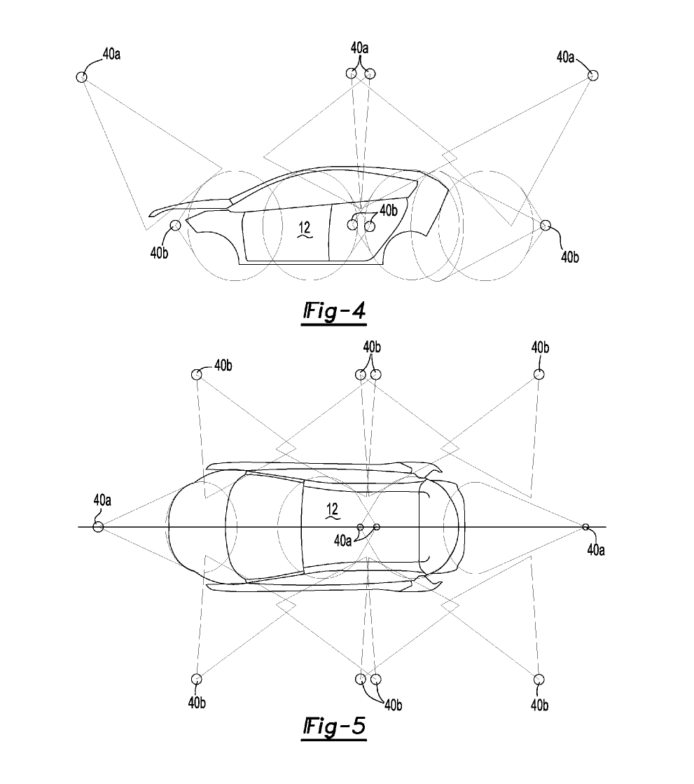

FIGS. 4 and 5, twelve cameras are provided in a configuration that may cover or capture images of the entirety of the surface or surfaces of the article 12. For instance, four superior cameras 40a may be disposed generally above the article. From left to right, the superior cameras 40a may be configured to view or cover a hood, roof, and trunk of a vehicle body in an automotive vehicular application. In addition four lateral cameras 40b may be disposed along the left and right sides of the article to view or cover the left and right sides of the article, respectively. The lateral cameras 40b may be disposed in a generally symmetrical arrangement along the left and right sides. In FIGS. 4 and 5, the support structure 20, illumination subsystem 22, and mounting brackets for the cameras 40 are omitted for clarity.

The cameras 40 of the vision subsystem 24 may be inclined with respect to a surface of the article 12 such that prisms of vision (or frustums) cover or gather image data for part of or for the entirety of one or more surfaces of the article 12. Synchronized movement of the light sources 34 of the illumination subsystem 22 may produce a reflection that sweeps the surface(s) of the article 12 covered by the prisms of vision. During such sweeping, light may be displaced between the two opposing walls of the prisms or ‘cones’ of vision without presenting occlusions. In other words, the inspection system 10 may be configured such that there are no interferences with the light between the light source 34 and between a surface of the article 12 and the camera 40. Alternatively, the inspection system 10 may be configured such that the illumination system 22, light source 34, and/or other structural elements may cross one or more cones of vision without the reflection from the entire surface being completely occluded. In such a configuration, the reflection of light may be demarcated by or be within the walls of the cones of vision. Merging the images captured by each camera 40 during illumination sweeping may result in the complete illumination of the object to be inspected.

Types of illumination sweeping may include horizontal sweeping and oblique sweeping. In horizontal sweeping, one or more light sources 34 are moved through or are visible to a cone of vision of the camera 40. In oblique sweeping, one or more light sources 34 are moved along a path or line described by the cone of vision of the camera 40. In this manner the light sources 34 are not visible to the camera 40; however, the specular reflection from the light sources 34 is visible. This configuration may reduce the space needed for illumination sweeping of one or more surfaces, such as for convex surfaces.

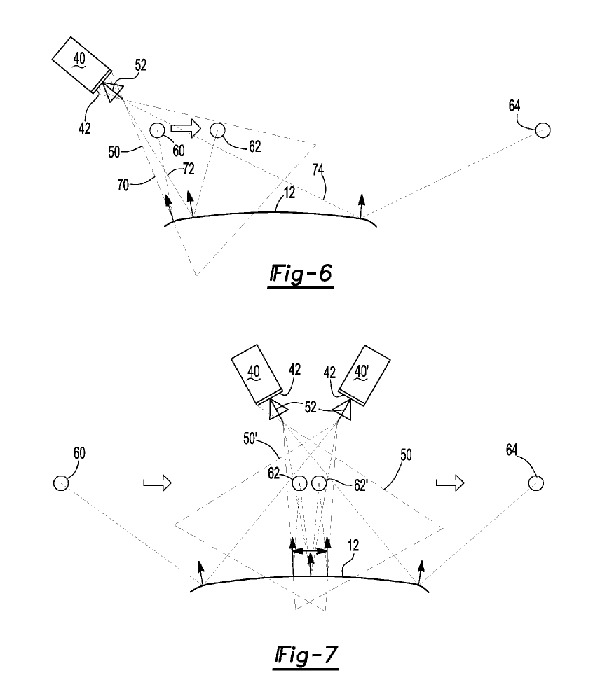

Referring to FIGS. 6-9, examples of horizontal sweeping are shown. FIG. 6 illustrates an embodiment having a single camera 40 while FIGS. 7-9 illustrate embodiments having multiple cameras 40. Multiple cameras may be utilized for larger articles that may not be visible or adequately viewed using a single camera. In such embodiments, the prisms of vision may overlap to obtain greater robustness in the process of calibration of the system and in the positioning of articles to be inspected.

Referring to FIG. 6, an embodiment having a single camera 40 is shown. The camera 40 has an image plane 42 (which may be the plane of an image sensor), a cone of vision 50, and an optical center 52. A light source 34 is shown in an initial position 60, an intermediate position 62 and a final position 64. The reflection of light from a surface of the article 12 when the light source 34 is in the initial, intermediate, and final positions 60, 62, 64 is indicated by 70, 72, and 74, respectively.

In FIG. 7, an embodiment having two cameras is shown. In this embodiment, first and second cameras 40, 40′ are shown having overlapping cones of vision 50, 50′ that overlap in an area that covers the article 12 to be inspected. A light source 34 moves between an initial position 60, a first intermediate position 62, a second intermediate position 62′, and a final position 64. The first and second intermediate positions 62, 62′ may correspond to positions where the illumination reflection appears in the first row or column of the images of the first and second cameras 40, 40′, respectively.

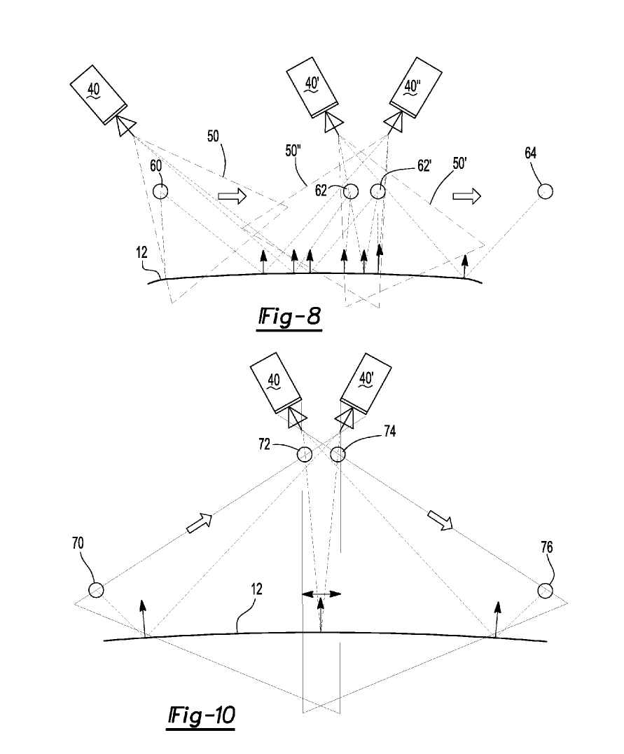

In FIG. 8, an embodiment having three cameras is shown. In this embodiment, first, second and third cameras 40, 40′, 40″ are shown having cones of vision 50, 50′, and 50″, respectively, that cover the article 12 to be inspected. A light source 34 moves between an initial position 60, a first intermediate position 62, a second intermediate position 62′, and a final position 64. The first and second intermediate positions 62, 62′ may correspond to positions where the illumination reflection appears in the first row or column of the images of the second and third cameras 40′, 40″, respectively.

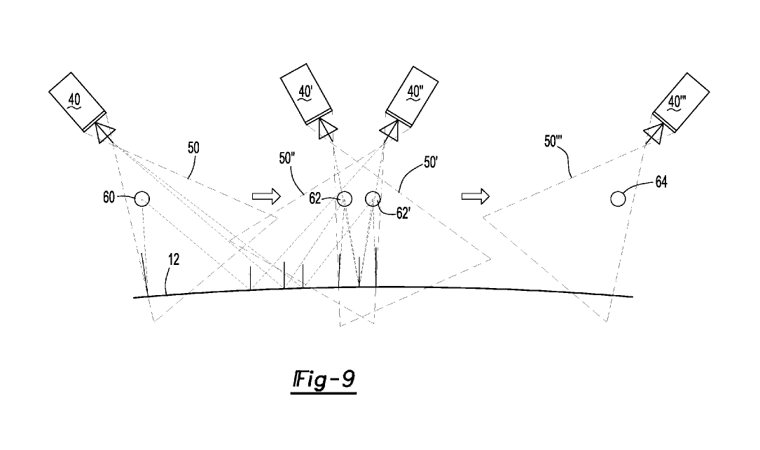

In FIG. 9, an embodiment having four cameras is shown. In this embodiment, first, second, third and fourth cameras 40, 40′, 40″, 40′″ are shown having cones of vision 50, 50′, 50″, 50′″ respectively, that cover the article 12 to be inspected. A light source 34 moves between an initial position 60, a first intermediate position 62, a second intermediate position 62′, and a final position 64. The first and second intermediate positions 62, 62′ may correspond to positions where the illumination reflection appears in the first row or column of the images of the second and third cameras 40′, 40″, respectively.

Referring to FIG. 10, an example of oblique sweeping is shown. In the embodiment shown, two cameras are provided, although a different number of cameras may be employed in various embodiments. First and second cameras 40, 40′ are inclined with respect to the article 12 to be inspected in a counterposed manner. A first light source 34 moves from an initial position 70 to a final position 72. A second light source moves from an initial position 74 to a final position 76.

Methodologies associated with the operation of the inspection system 10 will now be described. The methodologies may be executed in conjunction with the control subsystem 26, which may include a controller 80 that may be microprocessor based, and a display 82, such as a monitor or video display device for displaying information to an operator as shown in FIG. 1. The methodologies can be categorized as relating to image capture and image processing.

A method of image capture associated with the inspection system 10 will now be described. The method will be described primarily with respect to a vehicular application and assembly line, but may be applied to other articles and assembly processes as previously discussed.

First, the article to be inspected may be positioned with respect to the inspection system 10. In a vehicular application, the article 12 to be inspected may be moved to a desired position within the inspection system 10 by material handling equipment, such as a shuttle, conveyor, manipulator or any other suitable positioning device. The desired position for the article 12 may be a stationary position.

Second, the illumination subsystem 22 may be actuated to execute a sweep of the article 12. The sweep may be in a forward direction or a backward direction depending on the position of the illumination subsystem 22 by virtue of a previous inspection sweep. For example, the illumination subsystem 22 may move from the first position to the second position during a sweep or vice versa. During the sweep, the cameras 40 may gather data associated with light reflecting from the article 12 so that detects on a surface of the article 12 may be detected.

The speed of movement of the illumination system 22 may be based on the image acquisition speed of the camera 40 since reflections between images may be slightly superimposed. Employing multiple illumination arches 30 may help reduce the total sweep time as the sweep time may be inversely proportional to the number of illumination arches 30 when the initial position of one illumination arch is the final position of the previous illumination arch.

Third, after the sweep is complete the article 12 may be released and expelled from the inspection system 10.

A method of the processing images obtained with an inspection system 10 to detect defects will now be described. The method of image processing may help detect microdefects and macrodefects on specular or reflective surfaces, such as a painted surface.

Referring to FIG. 11, a flowchart of a method of image processing is shown. The methodology may be used for detecting and classifying surface defects.

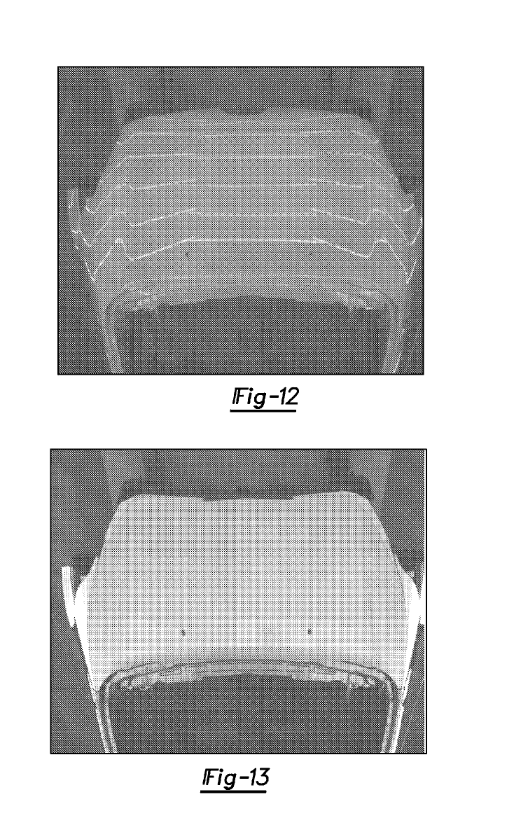

At block 100, the method begins by acquiring images. A set of images is acquired during illumination sweeping using the cameras 40. An example of such an image is shown in FIG. 12. The surface of the article 12 to be inspected may be completely illuminated by the sweep. The number of images acquired, referred to as variable M, may depend on the size of the article or object, the speed of illumination sweeping, and the maximum frequency of acquisition of images by the camera 40.

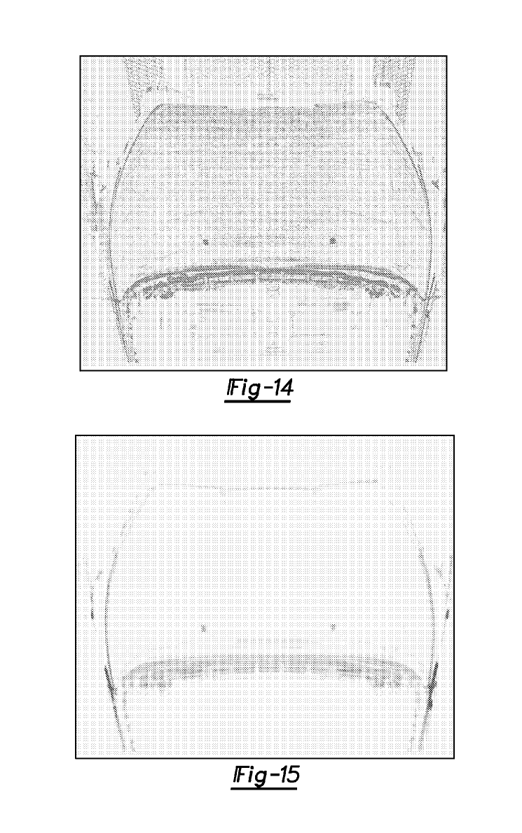

At block 102, the method merges the images acquired. A merged image is obtained through superimposition of all the images acquired. An example of such an image is shown in FIG. 13. Superimposition is achieved through applying, pixel by pixel, maximum grey scale operation of the images acquired during the illumination sweeping, that is to say:

I_{merging}=max{Iᵢₙ(1), Iᵢₙ(2), . . . , Iᵢₙ(M)}

where:

I_{merging} is the merged image, and

Iᵢₙ are one or more grayscale values associated with an image (indexed from image 1 to image M)

At block 104, the method compares and matches deviations in the merged image with respect to a model image. Comparison and matching may involve pattern searching and has the objective of compensating for small variations in the positioning of the object in conformity with the following expression, again applied pixel by pixel:

i_{matching}=R(θ)×I_{merging}+t

where:

I_{matching} is the matched image

R (θ) is a standard rotation matrix with orientation θ and displacement vector t

Pattern searching may include searching for features or characteristics that may identify a datum, edge, corner, hole, or other identification point or reference on the article. The resulting image may be interpolated in any suitable manner, such as by cubic approximation, to smooth and compensate for discretisation errors.

At block 106, the method blurs different levels of illumination provided by the light source(s). The purpose of this step is to obtain a homogeneous image with respect to lighting changes that is to be subtracted from the original image. An example of a blurred image is shown in FIG. 14. The blurring operation utilizes two operators ‘blurMinus’ and ‘blurPlus’ wherein the required image displacement to realize said operation is specified. Combining these operators appropriately a uniform image is obtained. The operators ‘blurPlus’ and ‘blurMinus’ realize positive and negative displacements on each of the axes, the sequence of displacements being {Y+, Y−, X+, X−}, concatenating the images. The blurPlus operation obtains the maximum between the input image and the displaced images, while the blurMinus operation obtains the minimum. Consequently the blurPlus operation obtains a lighter image, whereas the blurMinus operation obtains a darker image.

Mathematically the operators ‘blurPlus’ and ‘blurMinus’ are expressed in the following manner:

Iₒᵤₜ=max{max{max{max{Iᵢₙ,Iᵢₙ+Y+},Iᵢₙ+Y−}, Iᵢₙ+X+}, Iᵢₙ+X−}→blurPlus

Iₒᵤₜ=min{min{min{min{Iᵢₙ, Iᵢₙ+Y+}, Iᵢₙ+Y−}, Iᵢₙ+X+}, Iᵢₙ+X−}→blurMinus

At block 108, the method executes a thresholding strategy for binarisation of the image. The thresholding strategy generates a binary image (black and white). An example of such an image is shown in FIG. 15. This process is realized at pixel level in a local manner, that is to say each pixel may dispose of or employ a different thresholding level that may be a function of the inspection zone or area of the article inspected. The thresholding levels may change from pixel to pixel and may be predetermined values that correspond to characteristics of the article or region of the article being analyzed. This threshold image, I_{threshold}, determines the grey level for which the blurring image must be binarised. Consequently the operation of applying minimum pixel thresholding, I_{binary} (x,y) is 0 if I_{blurring} (x,y)≧I_{threshold} (x,y) or 255 in the contrary case.

There may be an automatic self-adjustment process of the threshold image wherein the level of each pixel depends on the zone visualized, such as distances, inclinations and color of the surface. The corresponding algorithm introduces an adjustment factor that takes into account the last N images in order to introduce better adaptation to small changes in colors and light conditions. This procedure may compensate for and eliminate the detection of undesired effects, such as orange peel.

Thresholding of the image may result in the creation of an image in black and white herein the background is dark and defects appear in white. In the thresholded image the defect may appear as a single pixel or as a group of pixels. This stage may compensate for problems deriving from non-homogeneous illumination that have not been resolved by blurring and, moreover, is intended to discriminate ‘orange peel’ existing on certain parts of the article which, in turn, differs as a function of the number of repaintings of the bodywork, the color and the model thereof. The thresholding is realized stagewise such that whilst one stage is being applied information is obtained for self-adjustment of the following stage. Specifically, the following stages are defined: global binarisation, self-adjustment as a function of beam width, and minimum pixel filtering. Thresholding through global binarisation of the entire image may have values determined in an experimental manner, with a linear operation on the input image modifying the grey levels thereof. In the second stage the linear operation may be modified by an exponential operation, the values whereof have been automatically self-adjusting as a function of beam width. Minimum pixel filtering is thresholding applied in an individualized manner to each pixel may render improved results. For this purpose a threshold image I_{threshold} is available determining the grey level in respect of which the image must be binarised. To be able to obtain the threshold image the learning process may be realized wherein every N times that a same body of a same model of car and color is being processed the new threshold image is calculated from the minimum of the N last images, as a weighted average.

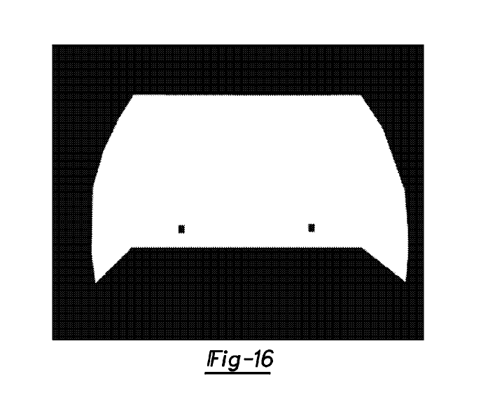

A mask may be utilized to filter and eliminate data from surface areas or inspection zones that are not of interest. An example of a mask is shown in FIG. 16. The mask may be used to help avoid the generation of false positives in the defect detection process, such as may occur at or near edges of images of the article. For instance, a mask may be provided in the general outline of the article and overlaid to conceal processed image data outside the boundaries of the article.

At block 110, the method may execute blob detection and/or may create a resolution map. A resolution map may be provided that relates the size of the defect in the image to the actual size of the defect on the inspected surface.

The resolution map may be rescaled taking into account the configuration of the illumination subsystem. This corresponds to and is completed by the amplification phenomenon through the merging of images, previously described in patent PCT/ES2007/000236, which is hereby incorporated by reference in its entirety.

At block 112, the method classifies detected defects. Defects may be classified and displayed in accordance with color coding as a function of size, defect type or other characteristic. An image with duly-coded defects may be displayed on the display 82 to help an operator locate a defect on the article 12 prior to the process of polishing and repair. Moreover, such defects may be overlaid over an idealized or actual image of the article.

Through this methodology, microdefects as well as macrodefects may be detected on specular surfaces. Macrodefects may be due to defects generated in pressing or painting processes or the adherence of dirt or surface imperfections. In particular, and with reference to painted car bodies, the following defect types have been detected and classified:

1) Microdefects of several isolated colors;

2) Macrodefects detected as multiple high-density microdefects having several color codes, such as orange peel, coverall mar, hose mar and sags;

3) Macrodefects detected as a few blobs (e.g., one or two), such as touch mar, bag mar, craters and sealer under a coating;

4) Macrodefects with lack of reflectance, such as heavy clear coat and dry clear coat; and

5) Macrodefects detected as small or medium-size blobs, such as solvent trap, heavy solvent trap and overspray.

The system and methodologies described above may allow the process of design of inspection systems and validation thereof to be performed by computer simulation. For example, a simulator of the inspection tunnel may be developed to validate the entire detection process. The inspection simulation is realized employing CAD models of the bodywork and may be fully parameterized.

Cameras may undergo extrinsic calibration by employing real images against simulated images. Such calibration may be an iterative process permitting obtainment of the real position of the cameras from matching between the real image obtained and the simulated image. In this manner discrepancies between theoretical configuration calculations and the real configuration of structure and elements may be resolved.

The vision and illumination subsystems having been calibrated against the CAD model, it may be possible to obtain the resolution map based on the pinhole model of the camera, utilizing intrinsic parameters thereof and the triangulation (faceting) of the surface to be inspected.

Automatic selection of the reference image for the matching stage may be obtained from a large number of merged images of the same bodywork (e.g., same article model).

Some regions of the first image may be defined to be considered in the process of adjustment of the remainder of the images. The displacement of the remainder of the images may be calculated with respect to the preselected image and the center of mass may be calculated and the image the displacement whereof is closest to said center of mass is sought. This permits selection in an automatic manner of the most-centered possible model image, through which the possibility of faults in the matching stage may be reduced.

While the best mode for carrying out the invention has been described in detail, those familiar with the art to which this invention relates will recognize various alternative designs and embodiments for practicing the invention as defined by the following claims.

1. An inspection system for detecting defects on a surface of an article, comprising:
a support structure;
an illumination subsystem having a plurality of light sources that move linearly with respect to the support structure; and
a vision subsystem including stationary first and second cameras, the first and second cameras having overlapping first and second prisms of vision, respectively;
wherein movement of the plurality of light sources produces a reflection that sweeps the surface between two opposing walls of the first and second prisms of vision.

2. The inspection system of claim 1 wherein the light sources are disposed on an illumination arch that is moveable with respect to the support frame.

3. The inspection system of claim 2 wherein a set of illumination arches are provided that are substantially equidistantly spaced apart.

4. The inspection system of claim 2 wherein the light sources are disposed in a plane.

5. The inspection system of claim 4 wherein the light sources are disposed along a top side, left side, and a right side of the article.

6. The inspection system of claim 1 wherein the light sources are disposed in an octagonal arrangement and surround the article.

7. The inspection system of claim 1 wherein the surface includes a coating.

8. A method of inspecting an article for surface defects comprising:
acquiring images of a surface of the article with a camera as a light source is moved with respect to the article;
merging images acquired by the camera;
blurring a merged image to compensate for variations in levels of illumination provided by the light source; and
detecting a defect based on blurring of the merged image.

9. The method of claim 8 wherein the step of merging images further comprises comparing the merged image to a model image to compensate for variations in positioning of article.

10. The method of claim 8 wherein the step of blurring the merged image further comprises executing a thresholding strategy to create a black and white image based on blurring of the merged image.

11. The method of claim 10 wherein the thresholding strategy includes calculating a threshold image based on a previous threshold image.

12. The method of claim 11 wherein the thresholding strategy includes calculating a threshold image based on a weighted average of a plurality of previous threshold images.

13. A method of inspecting an article for surface defects, comprising:
positioning the article in a stationary position;
actuating an illumination subsystem having a light source such that light reflects off the surface;
capturing images of light reflecting off the article with a camera;
processing the images to detect the presence of a defect on the surface; and
displaying a location of a defect.

14. The method of claim 13 wherein the step of processing the images includes merging the images to create a merged image.

15. The method of claim 14 wherein the step of processing the images includes comparing the merged image to a model image to create a matched image that compensates for variations in positioning of the article.

16. The method of claim 15 wherein the step of processing the images further includes creating a blurred image based on the matched image.

17. The method of claim 16 wherein the step of processing the images further includes executing a thresholding strategy to create a black and white image based on the blurred image.

18. The method of claim 17 wherein the step of processing the images further includes masking the black and white image to filter and eliminate data.

19. The method of claim 18 wherein the step of processing the images further includes generating a resolution map that relates the size of a defect in the image to an actual size of the defect on the surface.

20. The method of claim 19 wherein the step of processing the images further includes classifying the defect.
